(19) United States
(12) Patent Application Publication
(10) Pub. No.: US 2012/0321079 A1
(43) Pub. Date: Dec. 20, 2012

(54) SYSTEM AND METHOD FOR GENERATING ROUND KEYS

(75) Inventor: Amit Badole, Bangalore (IN)

(73) Assignee: Freescale Semiconductor, INC, Austin, TX (US)

(21) Appl. No.: 13/159,443

(22) Filed: Jun. 14, 2011

(51) Int. Cl. H04L 9/14

(52) U.S. Cl. 380/45

(57) ABSTRACT

A system and method for generating round keys used for encrypting and decrypting an input text block. A received cipher key is used to generate round keys that include round key words. Two round key words are generated at the same timebased on the word lengths of the input text block and the cipher key. The generation of round keys may be paused depending on the word lengths of the input text block and the cipher key.

### BACKGROUND OF THE INVENTION

The present invention relates to cryptography, and, more particularly, a system and method for generating round keys in a cryptography system.

Data security is one of the most critical aspects of the transmission and storage of confidential data. Data security entails protecting data from unauthorized access and modification. The most widely used approach for protecting data from unauthorized access and modification is cryptography. Cryptography algorithms use ciphers to encrypt a data block in order to render the data block useless to a user accessing it without proper authorization. Ciphers include a series of steps that transform the data block into a cipher text. The cipher text can be decrypted using a piece of auxiliary information known as a cipher key owned by an authorized user.

Ciphers may be classified into symmetric key algorithms and asymmetric key algorithms. Ciphers that use the same cipher key for both encryption and decryption are known as symmetric key algorithms and the ones that use different cipher keys for encryption and decryption are known as asymmetric key algorithms. An example of a symmetric key algorithm is the Rijndael algorithm. The Rijndael algorithm includes using a cipher key to transform an input plain text into an output cipher text. The transformation includes several rounds of intermediate steps that involve expansion of the cipher key into round keys used for performing the transformation steps.

FIG. 1A is a schematic diagram illustrating an encryption module 100 that operates in accordance with the Rijndael algorithm. The encryption module 100 includes a key expansion block 102, add round key blocks 104a and 104b, and a plurality of functional F1 blocks 106a-106d (referred to collectively as 106). Each functional F1 block 106 includes a sub-bytes block 108, a shift rows block 110, a mixed column block 112, and the add round key block 104b (as shown for F1 block 106d).

A cipher key is input to the key expansion block 102. The cipher key may include 4, 6, or 8 cipher key words, of which each cipher key word has a bit size of 32 bits. Thus, a cipher key having 4 cipher key words is 128 bits long. The key expansion block 102 applies several intermediate operations to the cipher key to transform the cipher key into a predetermined number of round keys. The predetermined number of round keys obtained depends on the architecture of the Rijndael encryption system. The Rijndael encryption system has two parameters that include word lengths of the cipher key and an input text block. The input text block is a portion of a plain text and may include 4, 6, or 8 input text words in which each input text word has a bit size of 32 bits. Thus, an input text block having 4 input text words is 128 bits long. Based on the values of the above mentioned parameters, the key expansion block 102 is programmed to generate the predetermined number of round keys as defined by the Rijndael algorithm. For example, when the bit sizes of both the cipher key and the input text block are 128 bits, the key expansion block 102 is programmed to generate 10 round keys. In another example, when the bit size of the cipher key is 192 bits and the bit size of the input text block is 128 bits, the key expansion block 102 is programmed to generate 12round keys. The round keys are stored in a memory (not shown) for further processing.

The intermediate operations applied on the cipher key to obtain the round keys include applying S-box on each byte of the cipher key to produce a first intermediate round key. Thereafter, a cyclic permutation is applied on the first intermediate round key to obtain a second round key. A XOR logic operation is applied on the second intermediate round key and a round constant word array to obtain a round key.

The input text block is provided to the add round key block 104a. A first round key is accessed from the memory in which the round keys are stored and transmitted to the add round key block 104a. The add round key block 104a applies a bitwise-XOR operation on the input text block and the first round key. The output of the add round key block 104a is provided to the series of functional F1 blocks 106. The remaining round keys, i.e. the second round key to the last round key, are also accessed from the memory and provided to the functional F1 blocks 106. At each functional F1 block 106, intermediate steps (as defined by the Rijndael algorithm) are applied on the input received from the previous functional F1 block and a round key using the sub-bytes block 108, the shift rows block 110, the mixed column block 112, and the add round key block 104b to obtain a cipher text block.

Referring now to FIG. 1B, a schematic diagram illustrating a decryption module 120 that operates in accordance with the Rijndael algorithm is shown. The decryption module 120 includes a plurality of functional F2 blocks 122a-122d (collectively referred to as 122). Each functional F2 block 122 includes an inverse shift rows 124, an inverse sub-bytes 126, an inverse mixed column 128, and the add round key block 104b (as shown for F2 block 122d).

To decrypt a cipher text block, the round keys that were used to obtain the cipher text block from a plain text block are generated. The key expansion block 102 applies several intermediate operations to the cipher key used during encryption to transform the cipher key into the predetermined number of round keys. The round keys obtained are then stored in a memory (not shown) for further processing.

The cipher text block is provided to the add round key block 104a and the last round key is accessed from the memory. The add round key block 104a then applies a bitwise-XOR operation on the cipher text block and the last round key. The output of the XOR operation is provided to the series of functional F2 blocks 122. The remaining round keys, i.e. a first round key, a second round key, a third round key, etc. are also accessed from the memory and provided to the functional F2 blocks 122. At each functional F2 block 122 intermediate steps (as defined by the Rijndael algorithm) are applied using the inverse shift rows 124, the inverse sub-bytes 126, the inverse mixed column 128, and the add round key block 104b to obtain the plain text block.

The above-described method followed for encryption and decryption requires memory space for storing the expanded round keys. Based on the word lengths of the input text block and the cipher key, the number of round keys required during encryption and decryption may be 10, 12, or 14. Thus, a considerable amount of memory is required for storing the round keys, which increases the cost of the cryptography system, and also increases the power consumption as additional silicon area and logic gates are required for the additional storage. Further, during encryption/decryption, the memory is continually accessed. This leads to an increase in the processing time of the encryption/decryption system, which degrades performance. It would be advantageous to have a system and method for round key generation that eliminates the above mentioned shortcomings.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1A is a schematic diagram illustrating a conventional Rijndael algorithm encryption module;

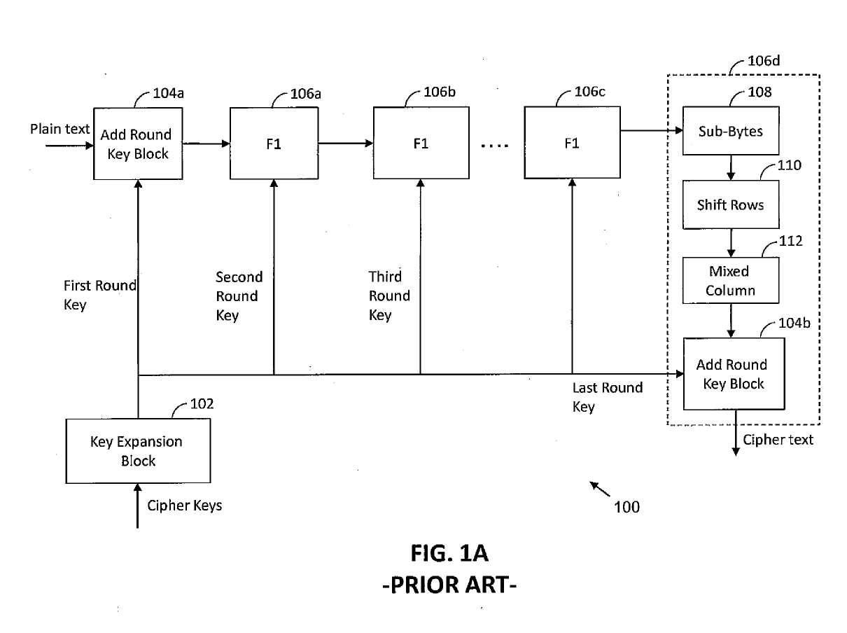

FIG. 1B is a schematic diagram illustrating a conventional Rijndael algorithm decryption module;

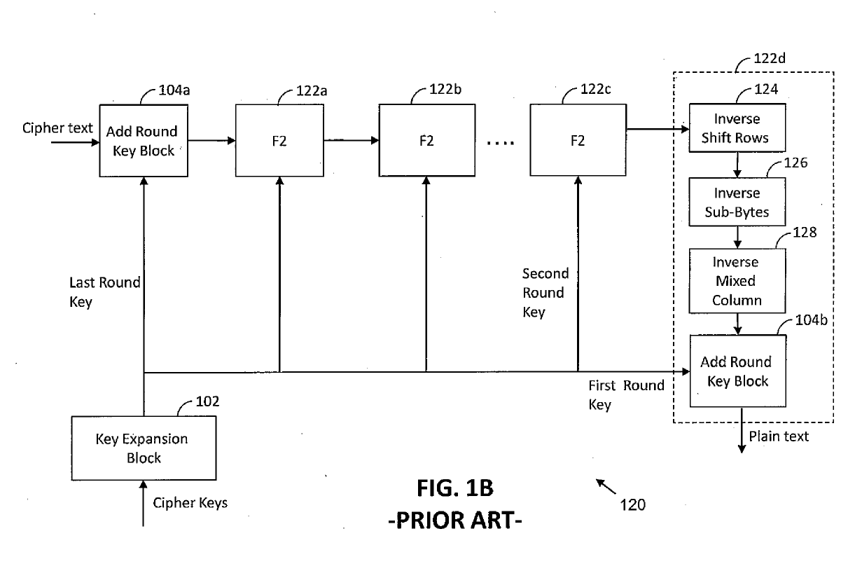

FIG. 2 is a schematic diagram illustrating a key expansion block in accordance with an embodiment of the present invention; and

FIG. 3 is a flow diagram illustrating a method for generating round keys in accordance with an embodiment of the present invention.

### DETAILED DESCRIPTION OF THE PRESENT INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In an embodiment of the present invention, a method for generating one or more round keys used for encrypting and decrypting an input text block is provided. A cipher key is received and round keys are generated using the cipher key during encryption or decryption of the input text block. A round key includes round key words of which two round key words are generated substantially simultaneously when a word length of the input text block is greater than a word length of the cipher key. The generation of the round keys is paused for a predetermined time period based on the word lengths of the input text block and the cipher key.

In another embodiment of the present invention, a system for generating one or more round keys used for encrypting and decrypting an input text block is provided. The system includes a first memory element for storing a cipher key that includes cipher key words, and a second memory element, connected to the first memory element, for storing the round keys, including the round key words. A first selection logic circuit is connected to the first memory element for selecting a first memory cell used to store a first cipher key word from the first memory element based on a first control signal. First and second functional blocks are connected to the first selection logic circuit, for applying intermediate operations associated with a cryptography algorithm to the first cipher key word. This leads to the generation of an intermediate round key word. The first and second functional blocks also generate an intermediate round key word substantially simultaneously based on a function signal.

The system further includes a second selection logic circuit connected to the first functional block, the second functional block, and the second memory element. The second selection logic circuit selects an output signal from one of the first and the second functional blocks and transmits the output signal to the second memory element based on a second control signal. A XOR logic block is connected to the first functional block, the second function block, and the second selection logic circuit. The XOR logic block performs a XOR logic operation on the intermediate round key word and a second cipher key word to generate a round key word. A control logic block connected to the first selection logic circuit, the second selection logic circuit, and the first and second functional blocks, generates the first control signal, the second control signal, and the function signal. The control logic block pauses and resumes the generation of the round keys using the function signal, wherein the function signal is generated based on the word lengths of the input text block and the cipher key.

Various embodiments of the present invention provide a system and method for the generation of round keys used for encryption and decryption of an input text block in accordance with the Rijndael algorithm. The round keys are generated using the cipher keys during run-time, i.e. when the encryption/decryption of the input text block is in progress. The generation of the round keys during run-time eliminates the need for a memory for the storage of round keys, as required by systems in which the round keys are generated prior to the beginning of the encryption/decryption process. This leads to a decrease in the manufacturing cost of the cryptography system because less memory space is required. Further, since logic gates required for implementing the memory are not required, the cryptography system consumes less power. Additionally, continual memory access is not required for reading the round keys, and hence the performance of the cryptography system is improved.

In accordance with the present invention, the round keys are generated as needed during run-time, i.e., when the number of the round keys utilized is less than the number of round keys generated, the generation of the round keys is accelerated by the use of identical twin functional blocks. Two cipher key words are provided simultaneously to the functional blocks resulting in the generation of the two round key words, thereby ensuring the availability of the round keys for use by the cryptography system. Further, if the number of round keys utilized is less than the round keys generated, the generation of the round keys is paused for a predetermined time period. This enables the use of any surplus round keys that may not have been utilized due to the smaller size of the input text block. The above described features of accelerating and pausing the round key generation enable the run-time generation of the round keys for all cipher key sizes (128/192/256 bits) and input text block sizes (128/192/256 bits).

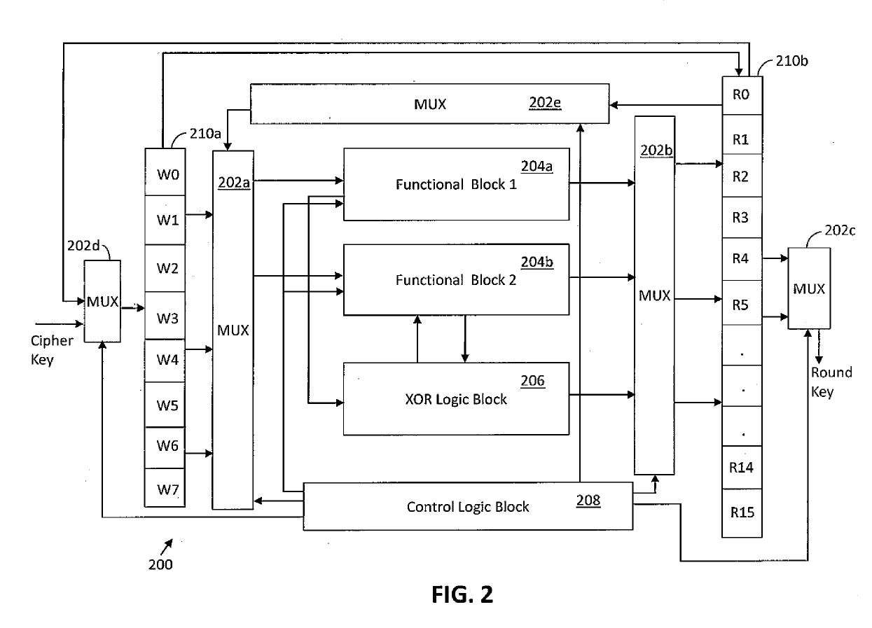

Referring now to FIG. 2, a schematic diagram illustrating a key expansion block 200 in accordance with an embodiment of the present invention is shown. The key expansion block 200 includes a plurality of selection logic circuits or muxes including a first mux 202a, a second mux 202b, a third mux 202c, a fourth mux 202d, and a fifth mux 202e, functional blocks 204a and 204b, an XOR logic block 206, a control logic block 208, and first and second memory elements or registers 210a and 210b. In an embodiment of the present invention, the first register 210a is 256 bits and includes 8 memory cells (W0-W7) with each memory cell having a size of 32 bits, and the second register 210b is 512 bits and includes 16 memory cells (R0-R15) with each memory cell having a size of 32 bits.

The fourth mux 202d has an output connected to the first register 210a, a first input connected to the second register 210b, a second input that receives a cipher key, and a control input connected to the control logic block 208. The control logic block 208 generates control signals for the muxes 202a-202e. The fourth mux 202d selects between its first and second inputs (i.e. the second register data and the cipher key) and provides the selected one as an output to the register 210a. The selection is performed based on a third control signal generated by the control logic block 208.

Each memory cell of the first register 210a, i.e. W0-W7, stores a cipher key word. In an embodiment of the present invention, the cipher key word has 32 bits and the cipher key may have a word length of 4, 6, or 8 cipher key words. Therefore, the cipher key may be 128 bits, 192 bits, or 256 bits long. The first register 210a is connected to the first mux 202a and the second register 210b.

The first mux 202a is connected to the fifth mux 202e, the functional blocks 204a and 204b, and the control logic block 208. The first mux 202a selects inputs received from the fifth mux 202e and the first register 210a, based on a first control signal generated by the control logic block 208 and provides the selected signal to the functional blocks 204a and 204b. The functional blocks 204a and 204b are connected to the control logic block 208. In an embodiment of the present invention, the functional blocks 204a and 204b perform the intermediate operations associated with a cryptography algorithm on a first cipher key word to generate an intermediate round key. Also in an embodiment of the present invention, the cryptography algorithm is the Rijndael algorithm. The intermediate operations of the Rijndael algorithm may include applying S-box on each byte of the cipher key word to produce a first intermediate round key word. A cyclic permutation is applied on the first intermediate round key word to obtain a second round key word. The XOR logic block 206 performs a XOR logic operation on the second intermediate round key word and a round constant word array and generates a third intermediate round key word. The XOR logic block 206 also performs an XOR logic operation on the third intermediate round key word and a second cipher keyword to generate a round key word.

In an embodiment of the present invention, a cipher key word is provided to either of the functional blocks 204a and 204b to generate an intermediate round key word. In another embodiment of the present invention, the cipher keyword is provided to both the functional blocks 204a and 204b to substantially simultaneously generate intermediate round key words based on a function signal generated by the control logic block 208. The function signal is generated by the control logic block 208 based on the word lengths of the input text block and the cipher key. In an exemplary embodiment of the present invention, the functional blocks 204a and 204b are signaled by the control logic block 208 to substantially simultaneously generate intermediate round key words when the word length of the input text block is greater than the word length of the cipher key. The control logic block 208 also signals the functional blocks 204a and 204b to pause the generation of intermediate round key words for a predetermined time period based on the word lengths of the input text block and the cipher key, and to resume the generation of the round key words when the predetermined time period has expired. For example, the functional blocks 204a and 204b are signaled by the control logic block 208 to pause the generation of the intermediate round key words when the word length of the input text block is less than the word length of the cipher key.

The fifth mux 202e is connected to the second register 210b and selects the data from one of the memory cells of the second register 210b and provides the selected data to the first mux 202a based on a fifth control signal generated by the control logic block 208. The functional block 204b is connected to the XOR logic block 206, which in turn is connected to the second mux 202b. The XOR logic block 206 performs a XOR logic operation on the received inputs (i.e., from the first and second functional blocks 204a, 204b) and provides the output to the second mux 202b. The second mux 202b is connected between the functional blocks 204a and 204b and the second register 210b. The second mux 202b selects one of the inputs received from the XOR logic block 206 and the functional blocks 204a and 204b, and provides the selected input to the second register 210b based on a second control signal generated by the control logic block 208.

The second register 210b is connected to the third mux 202c, which in turn is connected to the control logic block 208. The third mux 202c selects data from one of the memory cells of the second register 210b based on a fourth control signal generated by the control logic block 208 and provides the data as an output, i.e. round key to the encryption/decryption system for further processing.

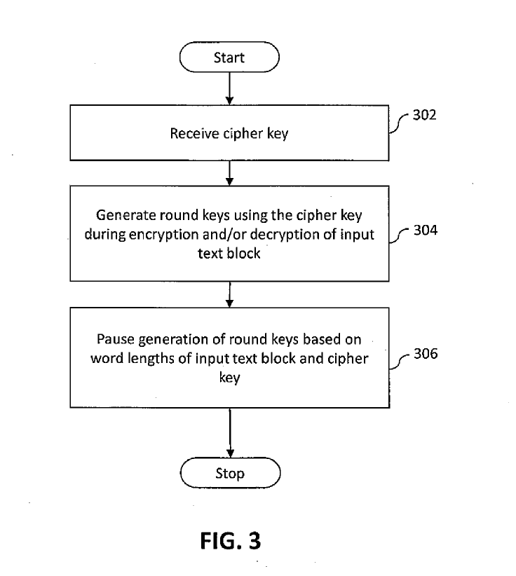

Referring now to FIG. 3, a flow chart illustrating a method for generating round keys in accordance with an embodiment of the present invention is shown. At step 302, a cipher key is received by the fourth mux 202d. In an example, the size of the cipher key and the size of the input text block is 128 bits. Therefore, the cipher key includes 4 cipher key words and the input text block includes 4 input text words. The generation of the round keys is performed at run-time, i.e. during the encryption or the decryption. The input text word may be either a portion of a cipher text or a plain text. During clock cycle 0, the fourth mux 202d transmits the cipher key words to the first register 210a based on a third control signal from the control logic block 208. The cipher key words are then stored in the memory cells W0-W3 of the first register 210a. At step 304, round key words are generated using the cipher key words stored in the first register 210a. This includes copying, during clock cycle 1, cipher key words from the memory cells W0-W3 of the first register 210a to the memory cells R0-R3 of the second register 210b. During clock cycle 2, contents of the memory cells R0-R3 are read as round key words for encrypting the input text block. Additionally, during clock cycle 2, round key words corresponding to the memory cells R4-R7 (of the first register 210a) are generated. The fifth mux 202e selects the memory cell R3 and transmits the corresponding cipher key word (first cipher key word) to the first mux 202a based on a fifth control signal generated by the control logic block 208. The first mux 202a transmits the first cipher key word to the functional block 204a and the functional block 204a then applies intermediate operations associated with a cryptography algorithm to the first cipher key word and generates an intermediate round key word. In an embodiment of the present invention, the cryptography algorithm is the Rijndael algorithm. The intermediate operations of the Rijndael algorithm include applying S-box on each byte of the first cipher key word to generate a first intermediate round key word. Then a cyclic permutation is applied on the first intermediate round key word to obtain a second intermediate round key word. The second intermediate round key word is transmitted to the XOR logic block 206 and a XOR logic operation is performed by the XOR logic block 206 on the second intermediate round key word and a round constant word array to obtain a third intermediate round key word. The XOR logic operation is also performed by the XOR logic block 206 on the third intermediate round key word and a second cipher keyword (corresponding to the memory cell RO of the second register 210b). This round key word is provided as an input to the second mux 202b. The second mux 202b transmits the round key word to the memory cell R4 of the second register 210b. The remaining round key words are generated during subsequent clock cycles in accordance with the Rijndael algorithm. The round key words are simultaneously generated and read to be used for encrypting or decrypting the input text block.

In an embodiment of the present invention, when the size of the input text block is greater than the size of the cipher key, i.e. when the input text block size is 256 bits and the cipher key size is 128 bits, or when the input text block size is 256 bits and the cipher key size is 192 bits, two round key words are generated substantially simultaneously to ensure that the round key words are available for encryption or decryption. In such a scenario, a cipher key word is transmitted to both the functional blocks 204a and 204b based on a control signal generated by the control logic block 208. The functional blocks 204a and 204b apply intermediate operations, in accordance with the Rijndael algorithm, on the cipher key words to generate the intermediate round key words simultaneously. The XOR logic block 206 performs a XOR logic operation on the intermediate round key words and cipher key words read from the second register 210b to generate two round key words simultaneously. This ensures that a round key word is available during the encryption/decryption of the input text block.

In another embodiment of the present invention, when the size of the input text block is less than the size of the cipher key, i.e. when the input text block size is 128 bits and the cipher key size is 256 bits, or when the input text block size is 128 bits and the cipher key size is 192 bits, step 306 is executed. At step 306, the generation of round keys is paused for a predetermined time period. In an embodiment of the present invention, the predetermined time period is 1 clock cycle. The generation of round keys is paused to ensure that the round key words that have not been used (due to size mismatch between the input text block and the cipher key) during the encryption/decryption process are used before new round key words are generated. Further, pausing the round key generation also ensures that additional memory is not required for storing the surplus round keys generated as a result of smaller size of the input text block. Thus, the present invention requires less memory than conventional round key generation systems.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for generating one or more round keys used for encrypting and decrypting an input text block, comprising:
receiving at least one cipher key;
generating the one or more round keys using the at least one cipher key during at least one of encrypting and decrypting of the input text block, wherein a round key comprises one or more round key words, and wherein two round key words are generated substantially simultaneously when a word length of the input text block is greater than a word length of the at least one cipher key; and
pausing the generation of the one or more round keys for a predetermined time period based on the word lengths of the input text block and the at least one cipher key.

2. The method of claim 1, wherein the round keys are generated using the Rijndael Algorithm.

3. The method of claim 1, wherein the at least one cipher key includes one or more cipher key words, and wherein the input text block includes one or more input text words.

4. The method of claim 3, wherein each of a round key word, a cipher key word, and an input text word comprises 32 bits.

5. The method of claim 4, wherein the word length of the input text block, the at least one cipher key, and the one or more round keys is at least one of 4, 6, and 8.

6. The method of claim 1, wherein a total count of the generated one or more round keys is based on the word lengths of the input text block and the at least one cipher key.

7. The method of claim 1, wherein generating the one or more round keys using the at least one cipher key comprises applying one or more intermediate operations associated with the Rijndael Algorithm to the at least one cipher key, to generate one or more intermediate round keys.

8. A system for generating one or more round keys used for encrypting and decrypting an input text block, comprising:
a first memory element for storing at least one cipher key, wherein the at least one cipher key comprises one or more cipher key words;
a second memory element, connected to the first memory element, for storing the one or more round keys, wherein each of the one or more round keys comprises one or more round key words;
a first selection logic circuit, connected to the first memory element, for selecting a first memory cell from the first memory based on a first control signal, wherein the first memory cell stores a first cipher key word;
first and second functional blocks, connected to the first selection logic circuit, for applying one or more intermediate operations associated with a cryptography algorithm to the first cipher key word, to generate at least one intermediate round key word, wherein each of the first and second functional blocks generates an intermediate round key word substantially simultaneously based on a function signal;
a second selection logic circuit, connected to the first functional block, the second functional block, and the second memory element, for selecting an output signal of at least one of the first and second functional blocks and transmitting the output signal to the second memory element based on a second control signal;
a XOR logic block, connected to the first functional block, the second function block, and the second selection logic circuit, for performing an XOR logic operation on the at least one intermediate round key word and a second cipher key word to generate a round key word; and
a control logic block, connected to the first selection logic circuit, the second selection logic circuit, and the first and second functional blocks, for generating the first control signal, the second control signal, and the function signal, wherein the control logic block pauses and resumes the generation of the one or more round keys, and wherein the function signal is generated based on the word lengths of the input text block and the at least one cipher key.

9. The system of claim 8, further comprising a third selection logic circuit, connected to the first memory element, the second memory element, and the control logic block, for selecting at least one of an input signal from the second memory element and the at least one cipher key input, based on a third control signal generated by the control logic block.

10. The system of claim 9, further comprising a fourth selection logic circuit, connected to the second memory element and the control logic block, for selecting a second memory cell from the second memory element based on a fourth control signal generated by the control logic block.

11. The system of claim 10, further comprising a fifth selection logic circuit, connected to the second memory element and the first selection logic circuit, for selecting a third memory cell from the second memory element based on a fifth control signal generated by the control logic block.

12. The system of claim 8, wherein each of a round key word, a cipher key word, and an input text word comprises 32 bits.

13. The system of claim 12, wherein the word length of the input text block, the at least one cipher key, and each of the one or more round keys is at least one of 4, 6, and 8 words.

14. The system of claim 13, wherein a total count of the one or more round keys is based on the word lengths of the input text block and the at least one cipher key.

15. The system of claim 8, wherein the input text block comprises at least one of a plain text and a cipher text.

16. The system of claim 8, wherein the cryptography algorithm is the Rijndael Algorithm.
